(19) United States
(12) Patent Application Publication
(10) Pub. No.: US 2012/0271645 A1
(43) Pub. Date: Oct. 25, 2012

(54) AUTOMATED REPLACEMENT PART ORDERING BASED ON SERVICE THRESHOLDS

(75) Inventors: Joseph Whitney Dain, Vail, AZ (US); Jeffrey Lee Fields, Tucson, AZ (US); Kelly Louise Hicks, Tucson, AZ (US); Frederick Scott Hunter Krauss, Raleigh, NC (US)

(73) Assignee: INTERNATIONAL BUSINESS MACHINES CORPORATION, Armonk, NY (US)

(21) Appl. No.: 13/092,898

(22) Filed: Apr. 22, 2011

(51) Int. Cl. G06Q 99/00

(52) U.S. Cl. 705/1.1

(57) ABSTRACT

Embodiments of the invention relate to the automatic ordering of replacement parts in product servicing. One aspect of the invention concerns a service system including multiple components, a service initiator for identifying a component in the system that has failed or does not operate according to a service threshold, and determining whether the identified component needs a replacement part based on the service threshold. The service system automatically orders a replacement part if the replacement part is needed and notifies a user of the part order. The service threshold may be dynamically adjusted.

Embodiments of the invention relate generally to computer systems, and more particularly, to automated ordering of replacement parts for components in a computer system based on established service thresholds.

### BACKGROUND

Whenever a hardware component in a computer system fails, the customer typically contacts a manufacturer's support center to report the failure and receive service support to correct the problem. If the support center determines that the failed component needs to be replaced, e.g., a disk drive unit in a computer, the support center may initiate the ordering of a replacement part to replace the failed component.

While this solution is viable, it creates delays and expenses for both the customer and the manufacturer. In order to minimize product service delays and expenses, product manufacturers are increasingly moving to a service model that is more simplified and automated, with some of the problem determination and repair tasks performed at the customer's site.

### BRIEF SUMMARY

Exemplary embodiments of the invention relate to the automated determination of part replacement for a component in a system and ordering of a replacement part for the affected component based on an established service threshold.

One aspect of the invention concerns a service system for determining whether a replacement part needs to be ordered for a component in the system being serviced and automatically ordering the replacement part if the part is needed. The system may comprise a plurality of interconnected components, a service initiator for identifying components in the system that are not operational or do not meet certain service thresholds, and determining whether a replacement part is needed for a component based on a service threshold. If a replacement part is needed, an ordering module of the service system automatically orders the replacement part without manual intervention.

Another aspect of the invention concerns a method for determining whether a replacement part is needed for a component in a system being serviced and automatically ordering a replacement part if the part is needed. The method may comprise identifying components in the system that are not operational or do not meet certain service thresholds, and determining whether a replacement part is needed for a component based on a service threshold. If a replacement part is needed, the method may include automatically ordering the replacement part without manual intervention.

A further aspect of the invention concerns a computer program product for determining whether a replacement part is needed for a system being serviced, and automatically ordering a replacement part if the part is needed. The computer program product comprises a computer readable storage medium having computer readable program code embodied therewith. The readable program code is configured to identify components in the system that are not operational or do not meet certain service thresholds, and determine whether a replacement part is needed for a component based on a service threshold. If a replacement part is needed, the program code may be configured to automatically order the replacement part without manual intervention.

The details of the preferred embodiments of the invention, both as to its structure and operation, are described below in the Detailed Description section in reference to the accompanying drawings. The Summary is intended to identify key features of the claimed subject matter, but it is not intended to be used to limit the scope of the claimed subject matter.

### BRIEF DESCRIPTION OF THE SEVERAL VIEWS OF THE DRAWINGS

FIG. 1 illustrates a block diagram of an exemplary product service environment in which aspects of the invention may be provided.

FIG. 2 illustrates a block diagram of an exemplary product service environment in which a service representative may interact with a service server to specify part service thresholds and receive service information, according to an embodiment of the invention.

FIG. 3 illustrates a block diagram of exemplary components in a service initiation system, according to an embodiment of the invention.

FIG. 4 illustrates a block diagram of exemplary components in a service server, according to an embodiment of the invention.

FIG. 5 is a flowchart of an exemplary process for identifying a component in a system that needs a replacement part and initiating the ordering of the replacement part, according to an embodiment of the invention.

FIG. 6 is a flowchart of an exemplary process for ordering a replacement part for an identified component, and communicating the part order status to the service initiation system, according to an embodiment of the invention.

FIG. 7 is a flowchart of an exemplary process for processing a replacement part order by a service server, according to an embodiment of the invention.

FIG. 8 is a flowchart of an exemplary process for setting a service threshold at which a replacement part for a component in a system is ordered, according to an embodiment of the invention.

FIG. 9 is a representative computer which may be part of a service initiation system, a service server, or a service workstation for providing aspects of the invention, according to an embodiment of the invention.

### DETAILED DESCRIPTION

Embodiments of the invention relate to the service of computer-related systems, and in particular, to the determination of components in the system that need to be replaced and automatically ordering the replacement parts for these components based on established service thresholds. The embodiments of the invention may be applicable to a wide range of products that have field replaceable components such as electronic cards, memory units, disk drives, and power components. Although computer products are used as examples for describing the embodiments of the invention, other types of systems with built-in electronic components such as appliances and machinery equipment may also include embodiments of the invention as described.

Large computer systems generally comprise multiple subsystems such as processing subsystems, storage subsystems, and communications-network subsystems. Some of these subsystems may be field-replaceable. Each subsystem may further comprise replaceable components such as electronic cards, memory units, disk drives, power supplies, cooling units, etc. During operation, any of these components may fail and become non-operational. In a typical scenario, upon knowing of the failure, a customer may contact the manufacturer's support center to receive the necessary product support service.

A service representative may perform a diagnostic procedure, either locally at the customer's site or remotely, to determine the source of the failure and affected components in the system. The service representative may conclude from the diagnostic procedure that one of the subsystems or components in the system has failed or does not operate according to certain requirements. In that case, the service representative may order a replacement unit for the identified subsystem or component if the subsystem or component is replaceable. Such a process is costly and time-consuming as it relies on the service representative's decision to order the part and the representative's initiation of the part ordering. The embodiments of the invention, as described, automate the problem determination and part ordering processes to minimize the need for human decisions and intervention by either the customer or the service representative, and thus minimizing the time it takes to bring the system back to operation and reducing service costs.

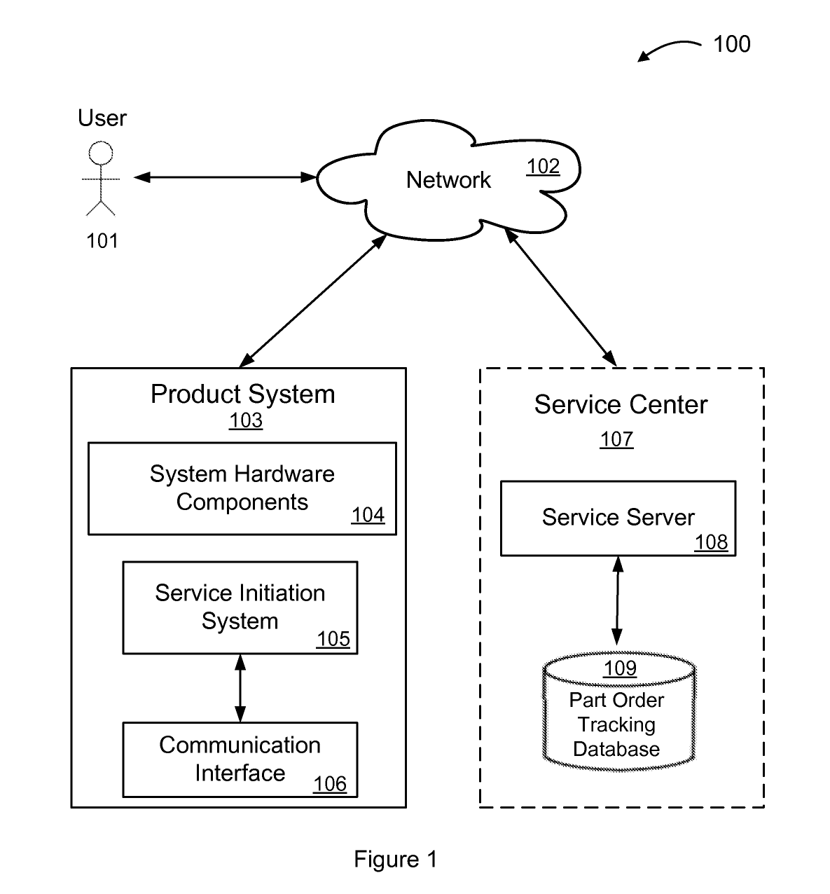

Referring now to the drawings and in particular to FIG. 1, there is illustrated an exemplary block diagram of a product service environment in which aspects of the invention may be implemented. The illustrated product service environment 100 may include a product system 103 that comprises multiple hardware components 104, e.g., data processing and storage subsystems, power supplies, and electronic cards. The product system 103 may include a service initiation system 105 for identifying components in the product system 103 that have failed or do not operate according to certain service requirements. The service requirements may be established in advance by a product or component manufacturer, product service center, or service representative, and may be in the form of operating or service thresholds. For example, a service threshold for a logic card in the product system 103 may relate to its maximum operating temperature. Another service threshold for the same logic card may relate to its operation duration in the field. In the present disclosure, the term “service threshold” broadly refers to thresholds that relate to both the operational characteristics and service characteristics of a component in the product system 103.

Upon identifying a component 104 in the product system 103 that does not operate according to certain service thresholds, the service initiation system 105 may determine whether to initiate an order for a replacement part for the identified component 104 and perform other service tasks for the component. If the service initiation system 105 determines that a replacement part for a component 104 is needed, it communicates with the service center 107, through the product system's communication interface 106, to request an order for the replacement part.

Communication interface 106 allows the product system 103 to communicate with and transfer data to and from a customer 101 and service center 107, via a network 102. The communication interface 106 may comprise appropriate network hardware and software components such as Ethernet network cards and programs supporting HTTP and TCP/IP network protocols.

The network 102 may comprise a private, public, third-party network, or a combination thereof, and may be a wide area network (WAN) or a local area network (LAN). A public network may be connected to the Internet through appropriate security protection.

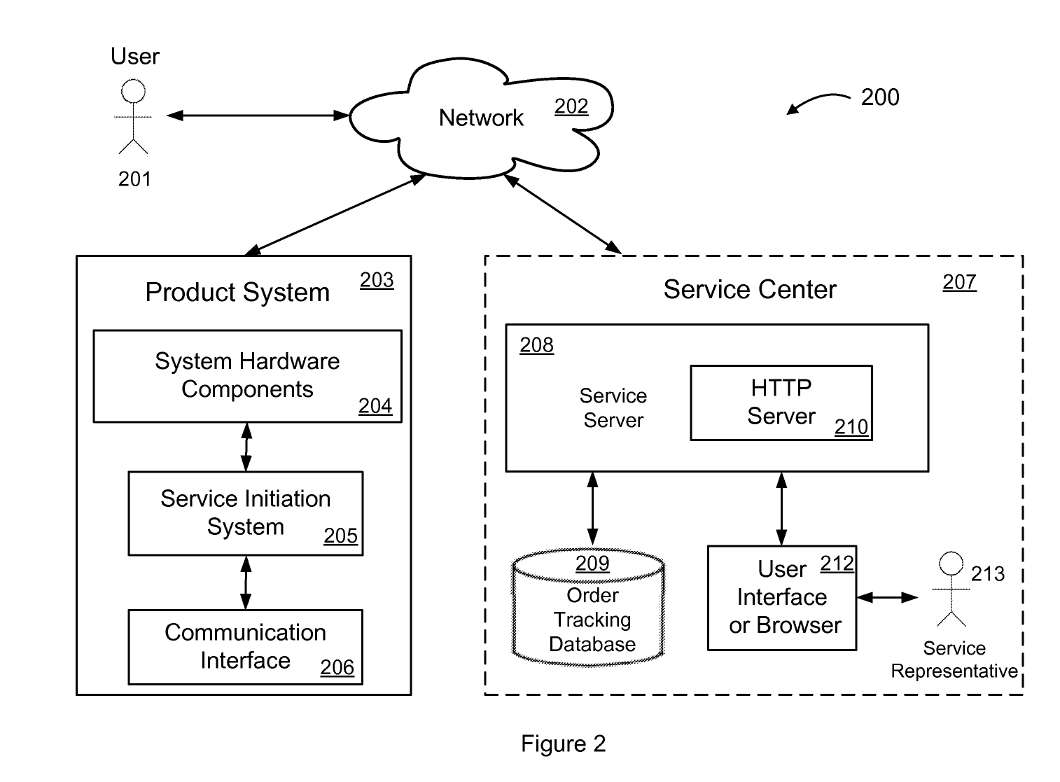

The service center 107 may include a service server 108 for processing and managing service requests and service actions relating to the products that the service center 107 supports, such as product system 103. The service server 108 may have a communications interface for receiving messages from users, customers, service representatives, products, and communications systems that have logical or physical connections to the service server 108. The service server's communications interface is further described with reference to FIG. 2.

The service server 108 may have access to a replacement part order tracking database 109 that contains information on the products supported by the service center 107. This information may include product model numbers, model numbers of the replaceable components for each product model, serial numbers of the replacement parts, details on the orders of replacements part, service requests and service actions.

FIG. 2 illustrates an exemplary product service system in which a service representative may interact with a service server 208 to specify part service thresholds and receive service information for components in a product system, according to an embodiment of the invention. In the illustrated service environment 200, a service server 208 may include an HTTP server 210 for communicating with users, customers, service representatives, products, and other communications systems that have communications links to the service server 208. For example, the HTTP server 210 may receive HTTPS messages from a remote product system 203 that contain service requests for the remote product system 203, such as a part replacement order request. A customer or user 201 may send a service inquiry for a product through the network 202 and HTTP server 210. In an embodiment, the customer 201 or product system 203 may communicate with the HTTP server 210 through web services over the Internet.

The service server 208 may be coupled to a graphic user interface or browser 212 to allow a service representative 213 to interact with the service server 208. For example, the graphic user interface or browser 212 may allow the service representative 213 to examine problem determination results sent by the service initiation system 205 to the service center 207 in connection with a service problem in product system 203. The service representative 213 may use the graphic user interface (GUI) or browser 212 to examine current service thresholds for a particular product or change these thresholds based on new service data from the field. The service thresholds, service requests and actions, and replacement part ordering information may be maintained in the order tracking database 209.

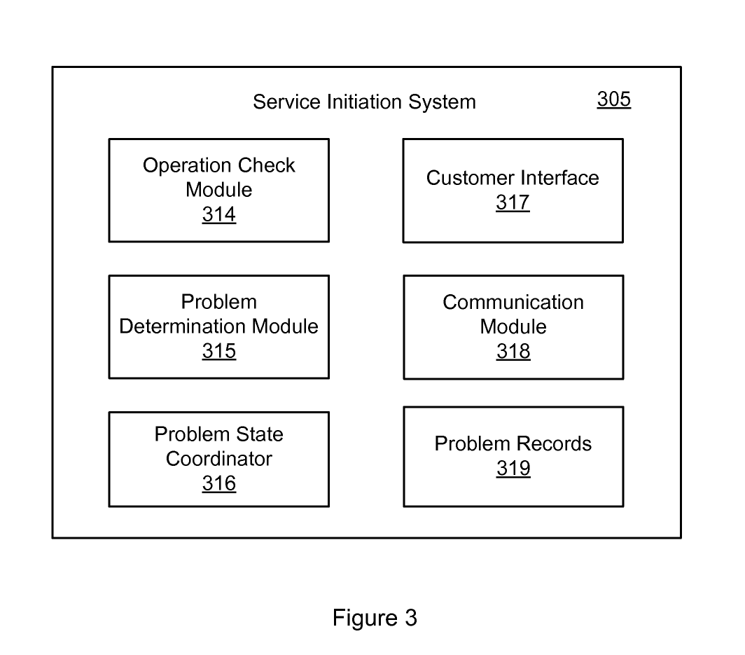

FIG. 3 illustrates a block diagram of exemplary components in a service initiation system 305, that may be part of a product system 203, according to an embodiment of the invention. The service initiation system 305 may include an operation check module 314 for periodically or continuously determining the operation status of each serviceable component in the product system 203. In an embodiment of the invention, the operation check may be provided by the product system 203's support code responsible for system functions related to the reliability, availability and serviceability (RAS) of the product.

The service initiation system 305 may comprise an interactive problem determination module 315 for analyzing a failure in the product system 203 and identifying one or more components in the system 203 that are related to a failure or service need. The service initiation system 305 may further include a problem state coordinator 316 for receiving and processing service messages generated by the problem determination module 315.

The problem state coordinator 316 may initially check the service messages that the service server 208 receives for their completeness and correctness. For example, upon receiving a problem record 319, the problem state coordinator 316 may examine the problem record 319 to determine whether it includes all necessary service entitlement details for the customer and information about the product being serviced. If the customer or product information is not complete, the problem state coordinator 316 may create a service error message to inform the customer of the incomplete message and request the customer to supply the missing information or contact the service center. If the customer and product information is complete, the problem state coordinator 316 continues with the processing of the problem record 319 as further described below.

The service initiation system 305 may include a customer interface 317 to allow the customer to interact with the service initiation system 305. The customer interface 317 may be in the form or a graphic user interface (GUI) or a browser. A communication module 318 may coordinate the communications between the service initiation system 305 and external systems such as the service center's part ordering and service threshold systems, and service representative workstations. For example, when a problem record 319 is generated by the service initiation system 305, the problem state coordinator 316 may call the communication module 318 and provide the problem record 319 to the communication module 318 to be sent to the service center 207. In an embodiment of the invention, the communication module 318 may initiate an HTTPS session to the HTTP server 210, with the problem record 319 included in the outgoing message.

If the HTTP operation is successful, the communication module 318 may wait for a reply message from the HTTP server 210 before continuing. If a reply message is received before a message timeout is exceeded, the communication module 318 may call the problem state coordinator 316 to report the successful delivery of the outgoing message. On the other hand, if the HTTP session initiation is not successful or if a reply message is not received within an established time period, the communicate module 318 may notify the problem state coordinator 316 of the communication failure.

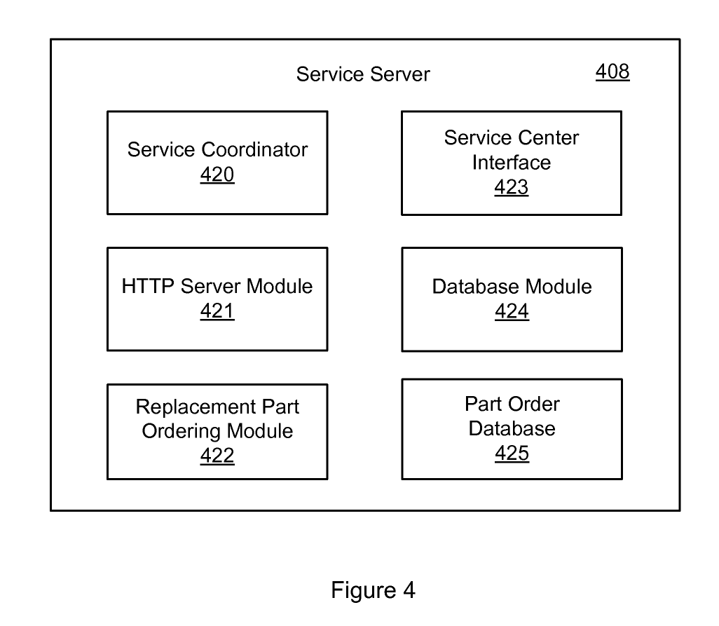

FIG. 4 illustrates a block diagram of exemplary components in a service server 408, which may be at a service center 207, according to an embodiment of the invention. The service server 408 may include a service coordinator 420 for processing service messages generated by the service server 408. HTTP server module 421 may receive communication messages sent by users, customers, products that the service center 207 supports, and service representatives. For example, the incoming messages may include HTTPS service requests from the product system 203. The HTTP server module 421 is also responsible for sending outgoing messages from the service server 408 to the users, customers, products that the service center 207 supports, and service representatives.

The service server 408 may comprise a part ordering module 422 for ordering for a replacement part, either through the manufacturer's part ordering system or a third-party's part ordering system. A service center interface 423 allows a service representative to interact with the service server 408, such as updating and querying information maintained in the part order tracking database 209. For example, using the service center interface 423 the service representative may check on the status of a pending part order, looking up a part's service thresholds, or changing the values of the thresholds.

Database module 424 may act as an interface between the modules 420-423 in the service server 408 and the order tracking database 425. For example, when the service coordinator 420 receives a part order status request message from the HTTP server module 421, the service coordinator 420 may parse the message and build an appropriate database query, based on the parsed message contents. The database query will execute on the database 425. The database query may include parameters that contain the product system 203's machine type model, machine serial number, problem record unique identifier, failed component serial number, and the location of a failed component in the product system.

Once the service coordinator 420 has generated the database query, it may call the database module 424 to process the database query using information in the part order database 425. After the query execution is completed, the database module 424 returns the database query results to the service coordinator 420. The query results may include the status of a replacement part order, shipping vendor, shipping tracking number, estimated arrival date, service entitlement information, and service threshold values.

The service coordinator 420 may further build an order status reply message based on the database query results and return the message to the HTTP server module 421. The HTTP server module 421 provides the reply message to the customer through the problem state coordinator 316.

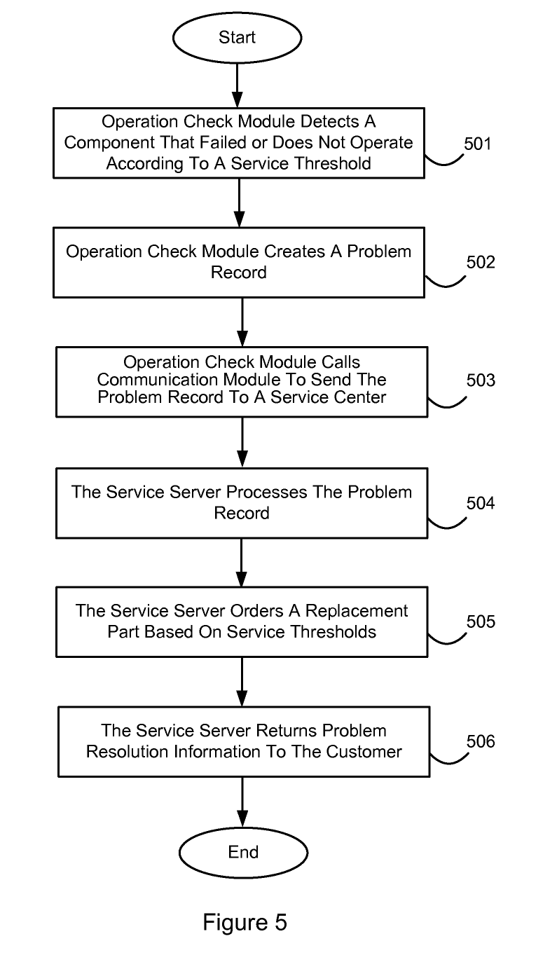

FIG. 5 is a flowchart of an exemplary process for identifying a component in a system that needs to be replaced and initiating the ordering of a replacement for the identified component, according to an embodiment of the invention. The process may begin at step 501 where the operation check module 314 detects that one of the replaceable components in the product system 203 has failed or does not operate in accordance with an established service threshold for the component. The operation check module 314 may create a problem record 319 for the identified component at step 502, based on a service policy for the product system 203. The problem record 319 typically contains information about the nature of the product failure, product and part information, service entitlement information, problem resolution status, and a replacement part request.

At step 503, the operation check module 314 may call the communication module 318 to send the problem record to the service center 207, via the HTTP server 210, for processing by the center's service server 208. Upon receiving the problem record, the service server 208 may parse the problem record 319 to extract details about the problem. If the service server 208 determines from problem details and service thresholds associated with an affected component that a replacement of the component is needed, then the service server 208 may initiate an order for a replacement part, at step 505. The service server 208 may return information about the resolution of the problem to the customer at step 506, which may include information about the ordering of a replacement part.

When a failure or a service condition is detected in the product system 203, the service initiation server 305 may initiate an outgoing HTTPS request to the HTTP server 210 to obtain part ordering status information for an identified component and the latest service thresholds at which replacement parts are automatically ordered. The outgoing HTTPS request message may contain information for uniquely identifying a failed component in a system or a component that does not operate according to an established service threshold. The information on the affected component may include the serial number of the component, a unique problem ID, the serial number of the system, and the location of the affected component in the system.

Once the HTTPS request message arrives at the HTTP server 210, the service server 208 may look up the part order tracking database 209 to obtain relevant information about the problem reported in the request message. The retrieved data may then be added to a reply message that will be sent to the product system 203. If the response message indicates that a replacement part has not been requested for the identified component, the service initiation server 305 may look at service threshold information returned from the database query (e.g., high, medium and low) and may perform the following activities based on the service threshold:
High threshold: the service initiation server 305 requests the customer to call the support center for assistance and does not send a request message to the service server 208 to order a replacement part.
Medium threshold: the service initiation server 305 requests the customer to run the problem determination module 315 before sending a request message to the service server 208 to order a replacement part.
Low threshold: the service initiation server 305 sends a request message to the service server 208 to request an ordering of a replacement part.

The part service thresholds are granular to the individual components in a product system and may be dynamically adjusted. For example, a service representative 213 at the service center 207 has the ability to dynamically change the service thresholds for serviceable components in a system. Such a function provides the ability to ‘turn off’ on a global scale the automatic ordering of replacement parts for a particular component or for all components in a supported system. For example, if the manufacturer has 2,000 systems in the field, the service representative 213 can globally set a service threshold that works with the automated ordering process such that the automatic replacement part orders for a specific part in all 2,000 systems are disabled.

On the other hand, if the response message indicates that a replacement part has already been ordered for an affected component in the product system 203, then the problem record associated with the service problem is updated with the part ordering information. The service server 208 notifies the customer of the part order status, including for example, shipping vendor, shipping tracking number, estimated part arrival date, etc.

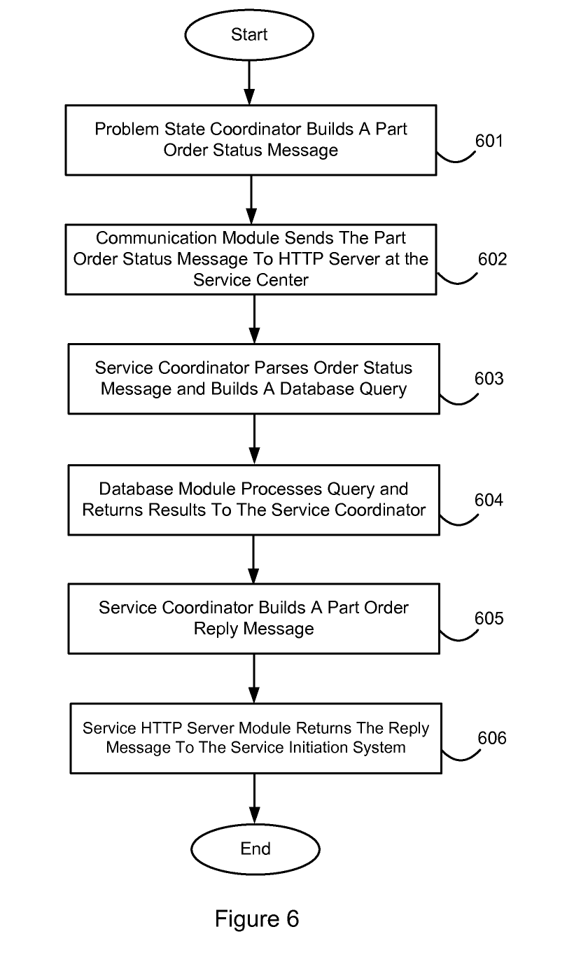

FIG. 6 is a flowchart of an exemplary process for ordering a replacement part for a component referred to in a problem record, and communicating the part ordering status to the service initiation system 305, according to an embodiment of the invention. Upon determining that a replacement part for the serviced component is needed, the problem state coordinator 316 in the service initiation system 305 may generate a part ordering message, at step 601. The problem state coordinator 316 may call the communication module 318 to transmit the part ordering message to the service coordinator 420, in the service server 408, through the HTTP server module 421 per step 602.

The service coordinator 420 may parse the part ordering message to extract details about the replacement part, e.g., part serial number, and builds a database query, at step 603. The database module 424 of the service server 408 processes the database query and returns resulting data to the service coordinator 420, at step 604. Using the returned data, the service coordinator 420 generates a replacement part order reply message in step 605 which the HTTP server module 421 may return to the service initiation system 305, at step 606.

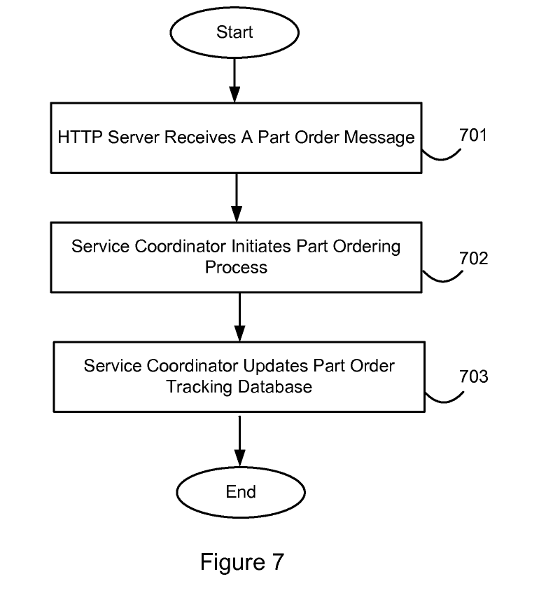

FIG. 7 is a flowchart of an exemplary process for processing a replacement part order by a service server 408, according to an embodiment of the invention. Once the service initiation system 305 sends a replacement part order request message to the service server 408, the HTTP server module 421 in the service server 408 receives the request message and begins its processing of the request at step 701. The HTTP server module 421 may call the service coordinator 420 and provide the part order request message to the service coordinator 420. The service coordinator 420 may invoke an automatic part ordering process at step 702 to order the replacement part. At step 703, the service coordinator 420 may call the database module 424 to update the part order database 425. This update may change the status of the part order, for example from “order placed” to “order pending”. Once the part ordering process is completed, the HTTP server module 421 may build and return a reply message to the service initiation system 305, per step 606 in FIG. 6.

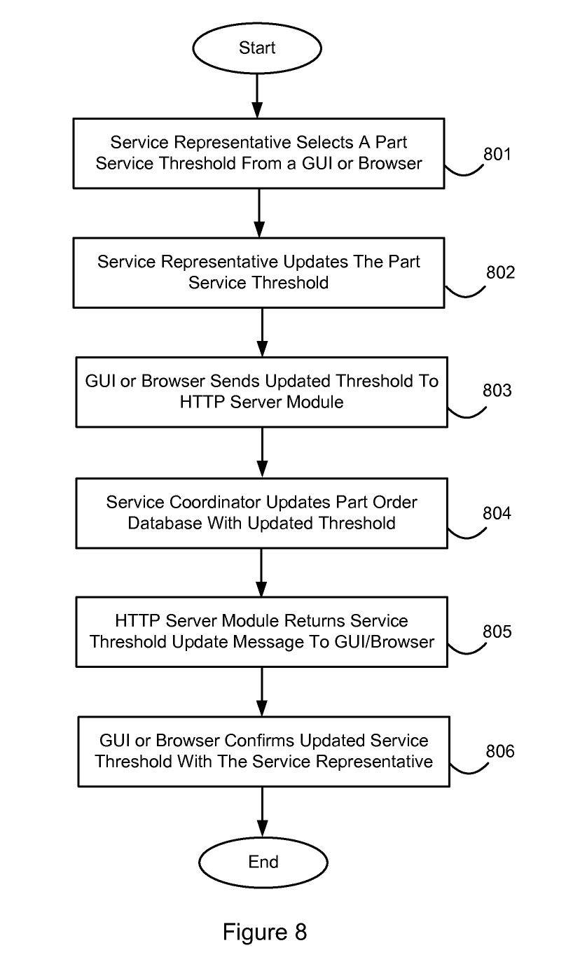

FIG. 8 is a flowchart of an exemplary process for updating a service threshold at which a replacement part is ordered for a component in a system, according to an embodiment of the invention. At step 801, a service representative may select from a list of service thresholds a particular threshold for a replaceable component in a product system. The part service threshold may be selected from a part database through a graphic user interface (GUI) or browser. The service threshold may be based on certain measurements relating the operation and performance of the respective part. The service representative may change the service threshold to a new value at step 802. For example, the service threshold for the part's operating temperature may be set not to exceed 100 degrees Fahrenheit.

In another embodiment, a service threshold may be set to initiate the ordering of a replacement part if there has been more than N number of service requests for a particular component. In yet another embodiment, a service threshold may be set to globally enable or disable automated part ordering on a specific part or to require users to execute a problem determination module prior to automatically ordering a replacement part.

The GUI or browser may send a threshold update request to the HTTP server module 421 which calls the service coordinator 420 to initiate a database operation to update the part threshold in the part order tracking database, at step 804. The HTTP server module 421 may return a threshold update message to the GUI or browser at step 805 which then notifies the service representative of the threshold update at step 806.

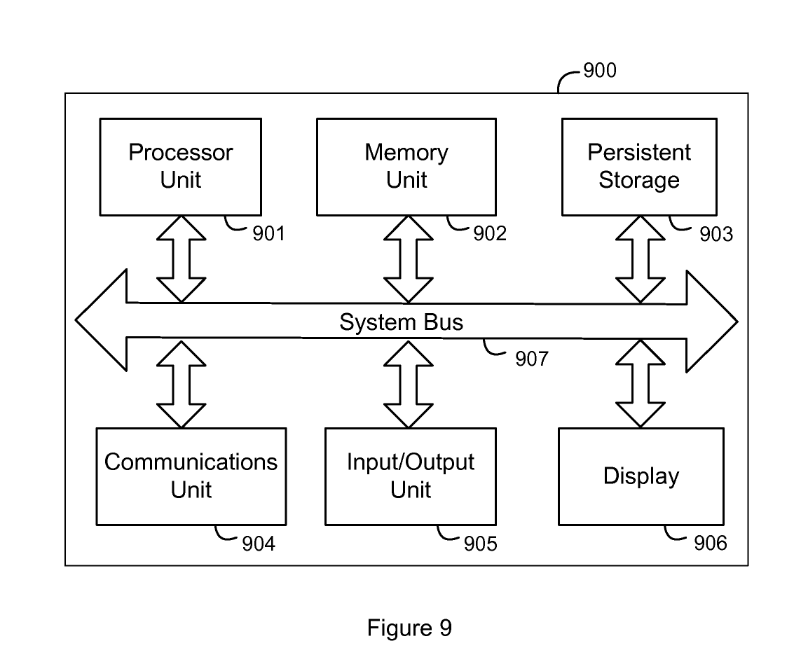

FIG. 9 is a block diagram of a representative computer which may be part of a service initiation system, a service server, or a service workstation for providing aspects of the invention, according to an embodiment of the invention. The computer 900 in FIG. 9 may include a processor unit 901, a memory unit 902, a persistent storage 903, a communications unit 904, an input/output unit 905, a display 906 and a system bus 907. Computer programs are typically stored in persistent storage 903 until they are needed for execution by an operating system, at which time the programs are brought into the memory unit 902 so that they can be directly accessed by the processor unit 901. The processor unit 901 may select a part of memory unit 902 to read and/or write by using an address that the processor 901 gives to memory 902 along with a request to read and/or write. Usually, the reading and interpretation of an encoded instruction at an address causes the processor 901 to fetch a subsequent instruction, either at a subsequent address or some other address. The processor unit 901, memory unit 902, persistent storage 903, communications unit 904, input/output unit 905, and display 906 may interface with each other through the system bus 907.

The subject matter described above is provided by way of illustration only and should not be construed as limiting. Various modifications and substitutions of the described components and operations can be made by those skilled in the art without departing from the spirit and scope of the present invention defined in the following claims, the scope of which is to be accorded the broadest interpretation so as to encompass such modifications and equivalent structures. As will be appreciated by those skilled in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, a “memory stick”, optical media, magneto-optical media, CD-ROM, etc.

As will be appreciated by one skilled in the art, aspects of the present invention may be embodied as a method, system or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a wide area network (WAN), Ethernet, SCSI, iSCSI, Fibre Channel, Fibre Channel over Ethernet, and Infiniband. The connection may be made to an external computer, for example, through the Internet using an Internet Service Provider.

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures described above illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A system comprising:
a plurality of components;
a service initiator for identifying from the system a component that requires service and determining whether the serviced component needs a replacement part based on a service threshold; and
an ordering module for automatically ordering the replacement part if the replacement part is needed.

2. The system of claim 1, further comprising an interactive problem determination module for determining a problem related to the serviced component wherein the interactive problem determination module is enabled on a per-component basis.

3. The system of claim 1, further comprising a service server for processing a replacement part order.

4. The system of claim 1, further comprising a user interface for viewing and querying the status of a replacement part order.

5. The system of claim 1, wherein the service threshold is dynamically adjusted to correspond to a condition when the serviced component is replaced.

6. The system of claim 1, wherein the ordering of the replacement part is communicated to a user.

7. The system of claim 1, wherein the ordering module obtains part replacement information for the serviced component from a part database.

8. The system of claim 1, wherein the part replacement order includes at least one of a part serial number, a problem identification, a machine serial number, and a location of the serviced component.

9. A computer implemented method comprising:
identifying, from a system of components, a component that requires service;
determining whether the serviced component needs a replacement part based on a service threshold; and
automatically ordering the replacement part if the replacement part is needed.

10. The method of claim 9, wherein the service threshold is dynamically adjusted to correspond to a condition when the replacement part is ordered.

11. The method of claim 9, further comprising notifying a customer of a replacement part order.

12. The method of claim 9, further comprising notifying a customer when the replacement part is shipped.

13. The method of claim 9, further comprising determining a service problem associated with the serviced component.

14. The method of claim 9, further comprising initiating a request to a service server to obtain the status on a replacement part order.

15. The method of claim 9, further comprising initiating a request to a service server to obtain the latest service threshold for the serviced component.

16. A computer program product comprising a computer readable storage medium having computer readable program code embodied therewith, the computer readable program code comprising:
computer readable program code configured to identify, from a system of components, a component that requires service;
computer readable program code configured to determine whether the serviced component needs a replacement part based on a service threshold; and
computer readable program code configured to automatically order the replacement part if the replacement part is needed.

17. The computer program product of claim 16, further comprising computer readable program code configured to notify a customer of a replacement part order.

18. The computer program product of claim 16, further comprising computer readable program code configured to notify a customer of a replacement part shipping.

19. The computer program product of claim 16, further comprising computer readable program code configured to initiate a request to a service server to obtain the status of a replacement part order.

20. The computer program product of claim 16, further comprising computer readable program code configured to allow a user to view and query the status of a replacement part order.
